(19) United States
(12) Patent Application Publication
(10) Pub. No.: US 2012/0315776 A1
(43) Pub. Date: Dec. 13, 2012

(54) CONNECTOR ASSEMBLY

(76) Inventors: Wei-Jia Liang, New Taipei (TW); Yu-Hung Su, New Taipei (TW)

(21) Appl. No.: 13/155,388

(22) Filed: Jun. 8, 2011

(51) Int. Cl. H01R 12/77

(52) U.S. Cl. 439/77

(57) ABSTRACT

A connector assembly adapted to be used in a wrist watch which has data transmission and storage functions, includes a connector including an insulating body and a plurality of terminals each having a soldering tail, and a FPC board acted as a watchstrap of the wrist watch or attached on an initial watchstrap of the wrist watch to electrically connect the connector and a circuit of the wrist watch. Wherein the soldering tails of the terminals are embedded in one end of the FPC board at regular intervals by means of solder press welding, then the one end of the FPC board together with the soldering tails of the terminals are molded in the insulating body as an integral, and the other end of the FPC board is electrically connected with the circuit of the wrist watch.

### BACKGROUND OF THE INVENTION

1. Field of the Invention

The present invention relates to a connector assembly, and more particularly to a connector assembly capable of meeting miniaturization demands of electronic products.

2. The Related Art

At present, electronic products capable of storing data therein, such as flash drives, audio and video players and so on, have been widely used in our daily life. Wrist watches having data storage functions also come with the tide of fashion, such as the wrist watch having the characteristic of MP3 or GPS. The wrist watch having the data storage function often needs a connector assembly including a data cable and a USB connector in addition so as to achieve charge and data transmission actions. One end of the USB cable is soldered with the USB connector, and the other end of the USB cable is electrically connected to a circuit of the wrist watch. However, the USB cable is apt to fall off and even be fractured from the USB connector after the wrist watch is worn and taken off again and again, on account of a weak soldering between the USB cable and the USB connector and a weak flexibility of the USB cable. Moreover, when the USB connector leaves unused, the USB cable needs to be placed into a receiving chamber opened in a watchstrap of the wrist watch for the convenience of wearing the wrist watch and a beautiful appearance of the wrist watch. But, it increases a whole thickness of the watchstrap of the wrist watch and results in a worse effect on comfortable wear of the wrist watch.

### SUMMARY OF THE INVENTION

An object of the present invention is to provide a connector assembly adapted to be used in a wrist watch which has data transmission and storage functions. The connector assembly includes a connector including an insulating body and a plurality of terminals each having a soldering tail, and a FPC board acted as a watchstrap of the wrist watch or attached on an initial watchstrap of the wrist watch to electrically connect the connector and a circuit of the wrist watch. Wherein the soldering tails of the terminals are embedded in one end of the FPC board at regular intervals by means of solder press welding, then the one end of the FPC board together with the soldering tails of the terminals are molded in the insulating body as an integral, and the other end of the FPC board is electrically connected with the circuit of the wrist watch.

As described above, the connector assembly of the present invention utilizes flexible, watertight, light in weight and small in volume characteristics of the FPC board to meet the demands of watertight, small and light wrist watches. Furthermore, the one end of the FPC board together with the soldering tails of the terminals are embedded in the insulating body as an integral when the insulating body is molded, so that further strengthens the connection between the soldering tails and the FPC board.

### BRIEF DESCRIPTION OF THE DRAWINGS

The present invention will be apparent to those skilled in the art by reading the following description thereof, with reference to the attached drawings, in which:

FIG. 1 is an assembled perspective view of a connector assembly according to an embodiment of the present invention; and

FIG. 2 is an exploded perspective view of the connector assembly of FIG. 1.

### DETAILED DESCRIPTION OF THE PREFERRED EMBODIMENT

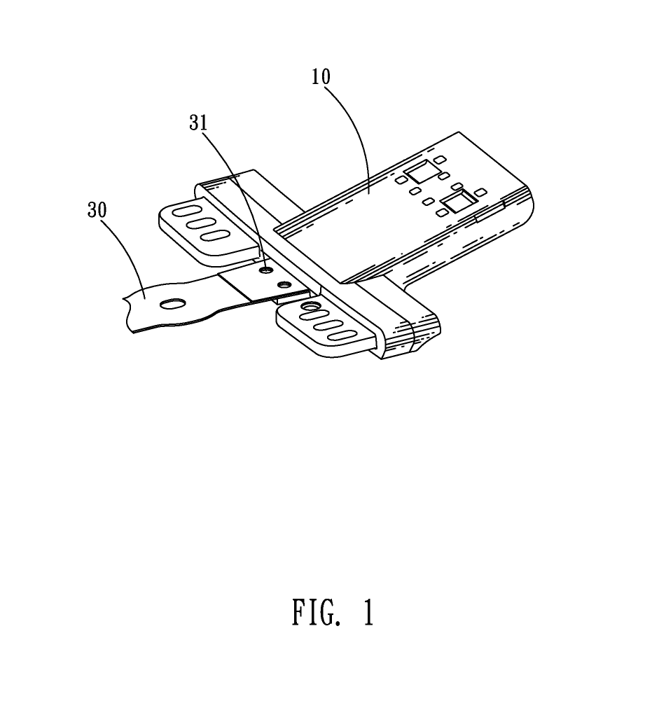

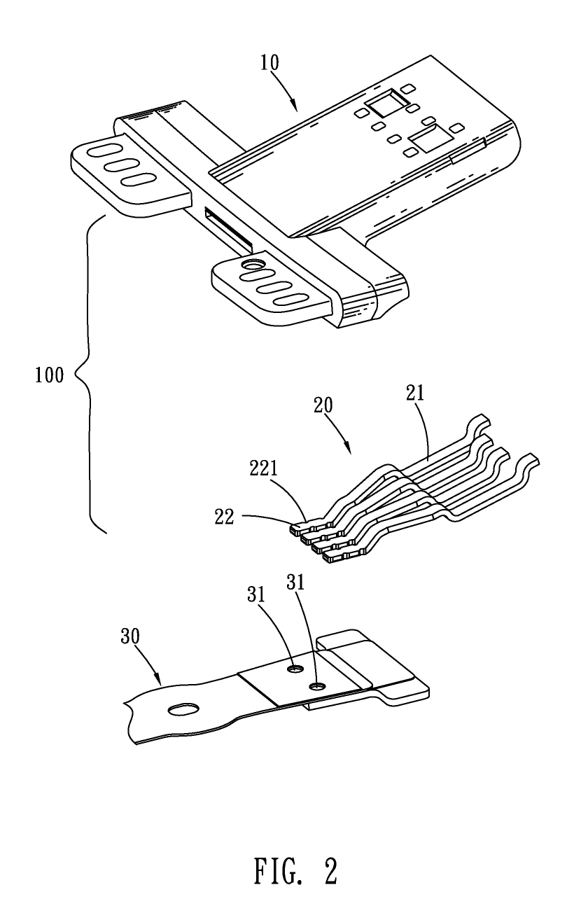

With reference to FIG. 1 and FIG. 2, a connector assembly according to an embodiment of the present invention includes a connector 100 and a FPC (Flexible Printed Circuit) board 30 electrically connected with the connector 100. The connector 100 includes an insulating body 10 and a plurality of terminals 20 soldered to one end of the FPC board 30 by means of solder press welding. Then the terminals 20 and the one end of the FPC board 30 soldered with the terminals 20 are together molded in the insulating body 10 once in a single mold (not shown).

Referring to FIG. 2, each of the terminals 20 has a contact arm 21 and a soldering tail 22 of which two side edges define a plurality of gaps 221 capable of gathering melted solder therein so as to strengthen the weld between the terminal 20 and the FPC board 30. The one end of the FPC board 30 soldered with the terminals 20 defines a plurality of positioning holes 31 used to securely position the FPC board 30 together with the terminals 20 in the single mold, when the insulating body 10 is molded in the single mold.

Referring to FIG. 1 and FIG. 2 again, when manufacturing the connector assembly, the soldering tails 22 of the terminals 20 are firstly embedded in the one end of the FPC board 30 at regular intervals by means of the solder press welding. Then, the one end of the FPC board 30 together with the terminals 20 are securely positioned in the single mold by means of a plurality of positioning pillars (not shown) inserted in the positioning holes 31 respectively, so as to mold the insulating body 10 around the one end of the FPC board 30 and the terminals 20. After the insulating body 10 is molded in the single mold, the soldering tails 22 of the terminals 20 and the one end of the FPC board 30 soldered with the soldering tails 22 are embedded in the insulating body 10 with the positioning holes 31 being exposed outside the insulating body 10, so that can further make the soldering tails 22 firmly secured with the FPC board 30 together.

In this embodiment, the connector assembly is used to a wrist watch (not shown) having a data storage function, for achieving data transmission and charge actions. The connector 100 is a USB connector, and the FPC board 30 is acted as a watchstrap of the wrist watch or attached on an initial watchstrap (not shown) of the wrist watch, with the one end thereof being embedded in the insulating body 10 and soldered with the soldering tails 22 of the terminals 20, and the other end thereof being electrically connected with a circuit (not shown) of the wrist watch.

As described above, the connector assembly of the present invention utilizes flexible, watertight, light in weight and small in volume characteristics of the FPC board 30 to meet the demands of watertight, small and light wrist watches. Furthermore, the one end of the FPC board 30 together with the soldering tails 22 of the terminals 20 are embedded in the insulating body 10 as an integral when the insulating body 10 is molded in the single mold, so that further strengthens the connection between the soldering tails 22 and the FPC board 30.

The foregoing description of the present invention has been presented for the purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A connector assembly adapted to be used in a wrist watch which has data transmission and storage functions, comprising:
a connector including an insulating body and a plurality of terminals each having a soldering tail; and
a FPC board acted as a watchstrap of the wrist watch or attached on an initial watchstrap of the wrist watch to electrically connect the connector and a circuit of the wrist watch,
wherein the soldering tails of the terminals are embedded in one end of the FPC board at regular intervals by means of solder press welding, then the one end of the FPC board together with the soldering tails of the terminals are molded in the insulating body as an integral, and the other end of the FPC board is electrically connected with the circuit of the wrist watch.

2. The connector assembly as claimed in claim 1, wherein two side edges of the soldering tail of the terminal define a plurality of gaps for gathering melted solder therein so as to strengthen the weld between the soldering tail of the terminal and the FPC board.

3. The connector assembly as claimed in claim 1, wherein the one end of the FPC board soldered with the soldering tails of the terminals defines a plurality of positioning holes apart from the soldering tails for positioning the FPC board together with the terminals during molding the insulating body to wrap up the soldering tails of the terminals and the one end of the FPC board.
